(19) United States
(12) Patent Application Publication
(10) Pub. No.: US 2022/0206864 A1
(43) Pub. Date: Jun. 30, 2022

(54) WORKLOAD EXECUTION BASED ON DEVICE CHARACTERISTICS

(71) Applicant: Intel Corporation, Santa Clara, CA (US)

(72) Inventors: Sundar NADATHUR, Cupertino, CA (US); Susanne M. BALLE, Hudson, NH (US); Andrzej KURIATA, Gdansk (PL); Duane E. GALBI, Wayland, MA (US); Nagabhushan CHITLUR, Portland, OR (US); Francesc GUIM BERNAT, Barcelona (ES); Alexander BACHMUTSKY, Sunnyvale, CA (US)

(21) Appl. No.: 17/694,516

(22) Filed: Mar. 14, 2022

(51) Int. Cl. G06F 9/50; G06F 8/65

(52) U.S. Cl. CPC G06F 9/5044; G06F 8/65; G06F 9/5055

(57) ABSTRACT

Examples described herein relate to causing execution of a workload on a device based on characteristics of the device and based on metadata associated with the device identifying execution requirements and software and hardware compatibilities between the device and a platform environment. In some examples, an accelerator device is selected to execute a workload based on characteristics of the accelerator device and based on software and hardware compatibilities between the device and a platform environment of the accelerator device.

### BACKGROUND

In cloud computing environments, compute devices execute workloads that perform specific operations. Accelerator devices, such as field programmable gate arrays (FPGAs) and Smart NICs, are reprogrammable and can be reconfigured with a different functionality, software interface, performance level, or other attributes. Some tasks are processed using computer programs that execute faster when carried out by a specialized component, such as a FPGA, an application specific integrated circuit (ASIC), or other device specifically configured for performing such computation. An accelerator device may be configured with a device image, a device profile, or a set of device configurations, to perform tasks assigned by a computer application.

### BRIEF DESCRIPTION OF THE DRAWINGS

FIG. 1 depicts an example system.

FIG. 2 depicts an example of metadata.

FIG. 3 depicts an example process.

FIG. 4 depicts an example system.

FIG. 5 depicts an example system.

### DETAILED DESCRIPTION

In a cloud environment, containerized applications can utilize shared devices. A computing platform can execute a software stack such as an operating system (OS) and a container orchestration engine (COE) (e.g., Kubernetes), associated infrastructure such as Container Network Interface (CNI) plugins, Container Storage Interface (CSI) plugins, and device plugins to manage execution of application containers. An application container can include device drivers, libraries, and runtimes to use and operate programmable devices (e.g., accelerators).

Reimaging a programmable device can change its functionality and its software interface. A specific device image configuration can be limited for use on a specific device (e.g., field programmable gate array (FPGA) or programmable ASIC) embedded in a specific platform (such as an Infrastructure Processing Unit). If the software stack is modified or updated, compatibility of the software stack with devices configured by device image configurations can occur in order to determine whether the software stack can access or utilize a programmable device configured with the modified or updated device image configurations. Changes to the software stack may lead to incompatibility with particular device image configurations executed by programmable devices, and to achieve compatibility between the software stack and the programmable device, either or both the software stack and/or device image configurations are to be changed.

A device image configuration can include one or more of: an executable image file for an FPGA, processor-executable instructions, or configuration for ASIC. A device image configuration can include a set of software binaries downloaded into embedded processor cores in the accelerator card. For example, the accelerator could be a PCIe card with a set of cores and the device image configuration can include a set of binaries downloaded for execution by the cores. A device image configuration can include a set of configuration parameters or a configuration profile for an ASIC. The operation and behavior of the ASIC can be based on the configuration profile and lock or unlock features, disable or enable higher performance, and so forth.

There may be several teams of software developers with distinct roles in the creation, updating, validation and deployment of device image configurations and software packages. System administrators, COE administrators, system or COE software developers, application developers and device image configuration developers are a few such roles. There may be validation roles that check the quality of individual components and other integration roles that ascertain compatibility of a specific software stack (e.g., TensorFlow with Intel® Math Kernel Library (MKL)) with a specific device image configuration, such as an FPGA bitstream for inference. Software packages and the device image configurations may be developed in-house, licensed from third-party vendor, or obtained from open-source repositories.

Accordingly, compatibility between a specific device image configuration and a software stack is to be identified in order to provide determinate compatibility of a software stack with a device image configuration executed by a programmable device, such as to select from one or more accelerator devices to execute a workload of a containerized application. A workload can include one or more operations offloaded from a processor or operations of the process itself. To potentially address an indeterminate compatibility of a software stack with a programmable accelerator, device image configurations, such as FPGA images and SmartNIC images, device image configurations can be associated with metadata that describes software compatibilities. Metadata associated with or added into an accelerator image file can specify one or more of an accelerator image function (e.g., compute operations, network operations, storage operations, security operations, compression algorithm, compression ratio, encryption type, decryption type, and so forth), system software compatibility (e.g., operating system compatibility such as compatibility with particular Linux versions, device interface compatibility (e.g., Peripheral Component Interconnect express (PCIe) or Compute Express Link (CXL)), virtualized interface capability (e.g., Single Root I/O Virtualization (SR-IOV) and Sharing specification, version 1.1, published Jan. 20, 2010 or Scalable I/O virtualization (Scalable IOV) (2017), or derivatives or variations thereof), functionality of the software stack to enable or utilize that functionality for a containerized application, software interface, attributes (e.g., performance, security, validation, quality check), software stack features; or compatible device families, configurations, platforms for the image. Metadata associated with a device image configuration can specify a particular device it can operate on (e.g., FPGA, graphics processing unit (GPU), XPU, ARM cores), a particular operation (e.g., compression, decompression, etc.) and particular format (e.g., raw binary file (.rbf), SRAM Object File (.sof), Programmer Object File for Remote Update (.pof), or others). Metadata can indicate performance levels (e.g., throughput rate in MBps, latency in ms), or relative levels (e.g., high/gold, medium/silver, regular/bronze). Metadata can indicate validation levels such as: untested, fully validated, tested for functionality but not interoperability.

The metadata may be a format that can be accessed and properly interpreted by software such as a workload orchestrator (e.g., Kubernetes or others) or microservices accelerator server in order to select a device image configuration to execute using a programmable device that operates with particular system software or to select a programmable device based on its device image configuration to execute a workload of a containerized application. A microservices accelerator server or orchestrator can determine a programmable device to perform a workload based on device image configuration function, device image configuration characteristics, or key performance indicators (KPI) or service level agreement (SLA) characteristics associated with the workload.

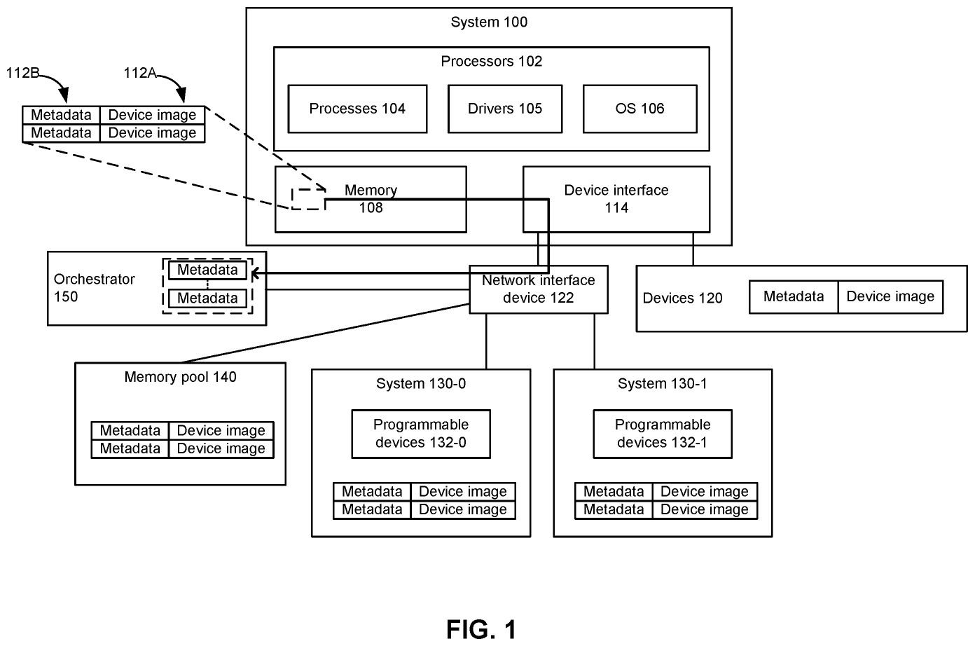

FIG. 1 depicts an example system. The system can be implemented as part of a server, rack of servers, computing platform, data center, multiple data centers, edge network device, or other environments. In some examples, various elements of system 100 can be formed as a system on chip (SoC). In some examples, processors 102 can include one or more of: a central processing unit (CPU) core, graphics processing unit (GPU), field programmable gate array (FPGA), accelerator or application specific integrated circuit (ASIC). Processors 102 can include an XPU, where an XPU can include at least to: a CPU, a graphics processing unit (GPU), general purpose GPU (GPGPU), or other processing units (e.g., accelerator). In some examples, a core can be sold or designed by Intel®, ARM®, AMD®, Qualcomm®, Broadcom®, Nvidia®, IBM®, Texas Instruments®, among others.

Processors 102 can execute an operating system (OS) 104, drivers 105, and/or processes 106. In some examples, OS 104 can include Linux®, Windows® Server, FreeBSD®, Android®, MacOS®, iOS®, or any other operating system. Drivers 105 can provide configuration and use of devices 120. Various examples of devices 120 include an accelerator, network interface device, storage, storage controller, memory, memory controller, or other circuitry.

Processors 102 can execute processes 104. One or more of processes 104 can include one or more of: applications, virtual machines (VMs), containers, microservices, serverless applications, thread, function, and so forth. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

Memory 108 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 108 can include static random access memory (SRAM) memory technology or memory technology consistent with high bandwidth memory (HBM), or double data rate (DDR), among others. Memory 108 can be connected to processors 102 and/or devices 120 using device interface 114. Device interface 114 can operate in a manner consistent with Double Data Rate (DDR), Compute Express Link (CXL) (e.g., Compute Express Link Specification revision 2.0, version 0.9 (2020), as well as earlier versions, revisions or variations thereof), Peripheral Component Interconnect express (PCIe) (e.g., PCI Express Base Specification 1.0 (2002), as well as earlier versions, revisions or variations thereof), or other interfaces.

Device image configurations 112A can include instructions executable by programmable devices such as devices 120, programmable devices 132-0 to 132-1, or other devices. Device image configurations 112A can be implemented using one or more of: firmware images, executable binaries, compute kernels, bitstream, configuration, image files, and so forth. Metadata 112B can be associated with a particular device image configuration 112A. Device image configurations 112A and associated metadata 112B can be stored as one or multiple files or data in memory 108, memory pool 140 (e.g., accessible through network interface device 122), devices 120 (e.g., accessible through device interface 114) and/or systems 130-0 to 130-1. Systems 130-0 and 130-1 can include components of system 100 and can execute workloads using programmable devices 132-0 and 132-1 configured using selected device image configurations. In some examples, device image configuration 112A includes a file with metadata 112B. The number of instances of system 130 is illustrative and more of fewer instances of system 130 can be available for use.

In some cases, programmable devices 132-0 and 132-1 can be configured using selected device image configurations to be ready for allocation of a workload for execution but not necessarily configured to particular a particular workload.

Metadata 112B can indicate functions of an associated particular device image configuration 112A as well as compatible system software, compatible device interfaces, and other characteristics of a programmable device when it executes a particular device image configuration 112A. For example, metadata 112B can identify a list of software packages, with permitted version numbers (e.g., minimum and maximum version numbers or range of permitted version numbers), that are to be executed by a host system. Versions can represent software validated to properly interoperate with a device image version. For example, if an FPGA is programmed with an image that offers Open vSwitch (OVS) functionality, the control plane components of OVS (e.g., ovs-vswitchd and ovsdb) are to be executed in the host to access the device with such image. Metadata 112B can indicate specific interfaces (e.g., PCIe interfaces) and specific functionality (e.g., compression or inference).

Metadata 112B can indicate permitted software package versions such as one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions.

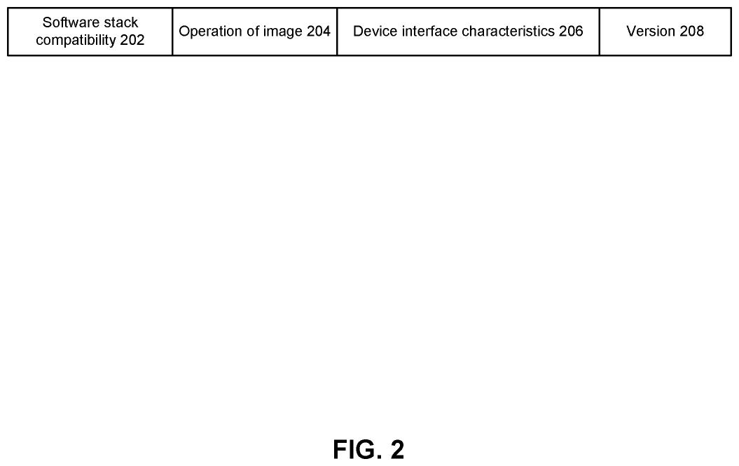

Metadata 112B can indicate compatible platform features such as host processor type (e.g., CPU, GPU, FPGA, etc.) and subtype (e.g., x86 or ARM CPU), processor size (e.g., number of cores, number of look up tables (LUTs), amount and type of integrated or external memory (e.g., amount of static random access memory (SRAM), amount of double data rate (DDR) memory, amount of High Bandwidth Memory (HBM), and so forth), low end network interface bandwidth (e.g., Ethernet), availability and capacity of security features, and so forth. Various examples of portions of metadata 112B are described with respect to FIG. 2.

Metadata 112B can be a format that can properly by read by orchestrator 150 or orchestrator 150 can translate metadata 112B to a format readable by orchestrator 150. Metadata 112B can be stored in a storage component, such as a registry, a database or a filesystem, which is accessible to orchestrator 150. For example, orchestrator 150 can access metadata 112B using tools such as Openstack Glance.

Some other component may provide attestation while the orchestrator verifies said attestation. Orchestrator 150 can access metadata 112B for one or multiple device image configurations 112A and, based on metadata 112B, determine which device image configuration to choose and whether to choose a device image configuration based on the target device and platform characteristics. Based on metadata 112B, orchestrator 150 can determine whether to update a device image configuration based on a particular target device and platform characteristics. Based on metadata 112B, orchestrator 150 can determine whether to install, update, or downgrade platform characteristics (e.g., software) to provide compatibility with a target device that executes a device image configuration associated with metadata 112B. Examples of orchestrator 150 include Kubernetes, Linux, Docker container orchestration, Azure AKS, Google GKE, Amazon EKS, Red Hat OpenShift, Platform9, and so forth. Orchestrator 150 can execute on a completing platform similar to system 100 and manage workload execution on system 100, devices 120, and systems 130-0 to 130-1.

For example, orchestrator 150 can initiate imaging or reimaging a programmable device with a device image configuration. For example, orchestrator 150 can image or reimage a programmable device with a device image configuration to add a new feature, achieve a new performance level, or scale up or down number of available functions.

Portions of metadata 112B can be encrypted so that certain devices or software (e.g., orchestrator 150) can access certain portions of metadata. Encryption may utilize public keys for specific devices or keys that may belong to groups of devices or entities. Encryption may use homomorphic encryption so that certain fields can be accessed without compromising or exposing additional portions of metadata 112B. Orchestrator 150 can decrypt metadata 112B and reject metadata 112B that is not authenticated. Metadata 112B may include information for attestation and other security functionalities of various system components. Metadata 112B can be attested by a developer or attestation process or server when associated device image configuration 112A is created or updated. Metadata 112B can be attested by orchestrator 150 or root of trust when associated device image configuration 112A is created or updated. A server root of trust (not shown) in an organization or the data center can be used to validate metadata 112B. During or after the device image configuration creation or update, a digest of device image configuration 112A and metadata 112B can be generated. For example, source, integrity, and/or confidentiality of portions of metadata 112 can be validated using one or more keys, a registry server, and so forth. A metadata 112B digest and universally unique identifier (UUID) of device image configuration 112A can be sent to an attestation server (not shown) to attest metadata 112B.

Metadata 112B may have certain portions that have particular access policies or properties that indicate that different entities accessing that portion of metadata 112B can access all or part of the metadata 112B. An access policy can be based on per user ID (UID) or per Group ID (GID) or per any other type of identification. Access policies may be stored in a device database (DB) or read only memory (ROM) and can be configured either out of band (OOB) or via specific application program interfaces (APIs) that require privileges. For example, access policies could be stored in a registry along with the metadata components, and the registry server enforces the access policies. For example, the access policies could be implicit in metadata components that are in the device image configuration file itself, signed with different private keys and those software components that have read access to a specific component are given the corresponding public key. Orchestrator 150 (e.g., workload and/or infrastructure orchestrator) can access portions of metadata 112B to validate what portion of metadata 112B can be provided to programmable device.

Metadata components can be stored in a registry, and orchestrator 150 and other components that access pieces of the metadata can query the registry and the registry server can enforce access policies. In some cases, different metadata components can be signed with different private keys and software components that have read access to a specific component can be given the corresponding public key.

In some examples, an administrator or tool can identify a set of device image configurations in a data center that share a common set of characteristics in order to update, report, or identify the device image configurations as obsolete.

Orchestrator 150 can select a particular device image configuration, particular programmable device, and/or platform connected to a particular programmable device based on device and system software configurations in metadata 112B. For example, based on metadata 112B, orchestrator 150 can determine if a specific device image configuration is compatible for use in a specific device (e.g., FPGA, programmable ASIC, GPU, or microprocessor) embedded or connected to a specific platform. For example, based on metadata 112B, orchestrator 150 can initiate automatic software changes in a system software stack to be compatible with a device that executes a device image configuration. Orchestrator 150 can determine compatibility of a device with a platform and workload based on metadata before the device is configured with device image configuration. For example, based on particular metadata 112B, orchestrator 150 can select a platform that includes devices and system software compatible with a programmable device when configured with the device image configuration 112A associated with the particular metadata 112B.

An automation tool (e.g., Chef, Puppet, Ansible) can determine a distribution version of system software executed by a host. The tool can install, update, or downgrade system software to be compatible with the distribution version associated with the image file. If the software stack is to be updated (e.g., by orchestrator 150 or security scan tool which triggers update), compatibility of the software changes with the prevailing device image configurations can be determined by orchestrator 150 or security scan tool. If a programmable device is to be reimaged as a result of software changes, available device image configurations can be chosen based on associated metadata indicating compatibility with the changed system software.

In some examples, a programmable device may store device metadata (e.g., in PCIe registers or memory) to self-identify the type and number of its resources. For example, an FPGA device plugin can either use the device metadata in lieu of metadata 112B or use device metadata and metadata 112B as complementary sources to cross-check them for integrity of compatible device characteristics.

FIG. 2 depicts an example of metadata. Metadata can include software stack compatibility 202. Software stack compatibility 202 can include a set of compatible software profiles such as a list of software packages, with a minimum and maximum compatible versions. For example, a software profile can refer to Linux distributions and range of compatible versions. For example, a software profile can refer to Centos 7.1-7.5, Centos 7.6 onwards, Ubuntu 18.04 and onwards. Some of the packages may provide basic operation while others may enable more advanced features or better performance. The entry for a software package may have additional qualifiers indicating mandatory or preferred compatibilities.

A YAML example format of software stack compatibility 202 can be as follows.

profiles:
centos:
   min-version: 7.1
   max-version: 7.5
   packages:
      ovs-switchd: “>=1.2.1, <1.5.0”
   ubuntu:
      min-version: 18.04
      max-version: 18.04
      packages:
         ovs-vswitchd: “>=1.2.1, <1.5.0”

Operation of image 204 can express functionality of a device image configuration. Example functionalities include compression, decompression, encryption, decryption, checksum generation and checking, and so forth. For example, for a function, a particular algorithm used can be specified (e.g., Lempel-Ziv-Welch (LZW) algorithm for compression), compression ratio versus time, and/or clock frequency settings for FPGA images. For example, capability of COMPRESSION using LZW algorithm and version 1.1 can be expressed as three key-value pairs: TYPE=COMPRESSION, ALGORITHM=LZW and VERSION=1.1. Labels can be accessed at a worker node, so that pod manifests can request specific labels as resources in order to schedule a workload for execution. Metadata associated with a device image configuration file is read by a software tool and translated to labels in worker nodes to indicate that the node itself is associated with that attribute. Labels (e.g., key-value pairs) can be applied on a Kubernetes worker node. If a pod manifest indicates a node with specific labels is mandatory, the Kubernetes scheduler can schedule the pod on a node with matching labels.

Kubernetes manifests (e.g., pods, deployments, StatefulSets, etc.) can request one or more of the exposed node labels and key-value pairs. A Kubernetes scheduler could place a workload to execute on a node or platform and devices based on functionality and compatibility between a software stack and device image configuration.

Device interface characteristics 206 can include device interface type and associated characteristics. For example, for a PCI interface used by the device image configuration, when executed, Single Root I/O Virtualization (SR-IOV) device plugin configuration files or characteristics can include Peripheral Component Interconnect Express (PCIe) identifiers (IDs), number of Physical and virtual PCIe functions, FPGA controllers, and so forth. The configuration files may be included in their entirety or as deltas to previously stored configuration files in the host.

Version 208 can represent version value of a particular metadata as there can be multiple versions of metadata for a device image configuration. An orchestrator can select a metadata to process based on a value of version 208 in some examples.

Device image configuration metadata can be partitioned based on its creator, updater, and consumer. Sections of metadata can be mapped to data center roles and particular data security policies can apply to the metadata to support governance and security models. For example, metadata partitions can be separately signed (e.g., for authentication and integrity) and encrypted (to limit access by unauthorized consumers). Metadata associated with a device image configuration can include portions that are processed by particular software or devices. Portions of metadata can be grouped whereby a group of attributes can be applied or processed as a whole.

Metadata can be formatted to be properly interpreted and decoded by consuming software or device. Metadata can be hierarchical such as where multiple entities add or remove the metadata, such as in a service chain use case. Metadata dependencies can be utilized to enforce FPGA based processing such as if a prior stage had been performed by an FPGA. For example, hierarchical data can be expressed in JSON or YAML formats. Tools can convert metadata's native format (e.g., JSON/YAML) to K8s labels. Such tools can be a part of, or be invoked by, an infrastructure orchestrator 150 that scheduled programming of a device.

For Kubernetes deployments, metadata can be formatted using labels or key-value pairs, with a prescribed character set and subject to a maximum length. With such formatting, toolchains can automatically apply labels to the Kubernetes worker node in which the device resides so that workload's pods can request such labels. Toolchains can automatically associate the key-value pairs, in the metadata or derived from the metadata, with entities in the host. For example, an FPGA device plugin can access a type and number of exposable Kubernetes resources.

Some metadata may not fit as labels or key-value pairs. For example, performance profiles, device characterization profiles such as frequency, temperature, power, voltage curves, or other parameters can be specified to indicate compatibility with platform power or temperature controls. For a particular workload, the orchestrator can choose a device image configuration among device image configurations based on the image's performance profile based on fields in the pod manifest, which in turn can be added based on a customer's profile (e.g., gold, silver, etc.). Device characterization profiles such as frequency, temperature, power, voltage curves, or other parameters may be used during a development process. For example, a developer can add some metadata fields, a validator can access the metadata fields to carry some tests and record a range of parameters (e.g., frequency, temperature, and so forth) for which the tests pass, to classify the quality of the image or intended use (e.g., military, aerospace, etc.) Subsequently, the orchestrator can use such added information to make its selection of devices, device image configurations, platforms, or software.

A performance profile may be expressed qualitatively (e.g., “High”), as a graded rank (e.g., 1-5), as a clock frequency metric, or some combination of these. The performance may also be expressed as a profile, e.g., how it changes as some input characteristic (such as the size of the input data) changes. The quality may be expressed qualitatively (e.g., “High”), as a graded rank (e.g., 1-5), or some standard FPGA quality metrics (such as frequency, temperature, power or voltage curves). For example, the metadata could be a set of JSON files, and two of them relate to performance and quality, and the performance part may indicate “{“performance”: {“frequency”: “100 Mhz”, “compression-time”: . . . }”. The orchestrator can select a device to perform a workload based on such metadata.

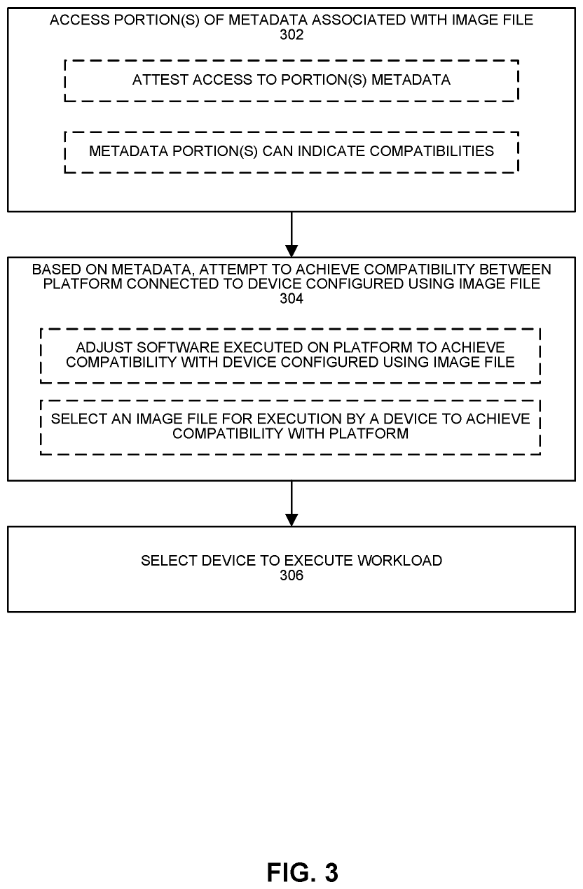

FIG. 3 depicts an example process. The process can be performed by an orchestrator or other workload execution manager software or device. At 302, metadata associated with one or more image files can be accessed. In some examples, accessing the metadata can be based on imaging or reimaging a programmable device with a device image configuration to add a new feature, achieve a new performance level, or scale up or down number of available functions. A device image configuration file creator or updater can attest the metadata, or portions thereof. The orchestrator can verify the authenticity or integrity of the metadata components that it is allowed to access. In some examples, accessing the metadata can involve decryption or validation to limit accesses to the metadata to permitted processor-executed software or devices. If decryption or validation fails, the process can end and an administrator can be notified that an attempt to access metadata failed.

The metadata can include multiple portions or partitions that include information generated by one or more developers while developing the associated image file. The metadata can indicate system software that is compatible with the image file, when executed by a programmable device. The metadata can indicate device interfaces used to communicate with a programmable device that executes the image file. For example, the one or more image files can be executable on programmable devices in a platform or platforms and the platform or platforms execute software stacks and include device interfaces that communicate with the programmable devices.

At 304, based on characteristics indicated in the metadata, compatibility between a platform and programmable device that executes the image file can be attempted to be achieved. For example, a software update of a platform can be performed to provide compatibility between the platform and the programmable device that executes the image file associated with the metadata. For example, a different device image configuration can be selected based on metadata associated with the different device image configuration indicating that software compatibility is present between the platform and the embedded or coupled programmable device.

At 306, the orchestrator can select a programmable device that executes an image file that is compatible with the platform to execute a workload. The programmable device can be located on a platform accessible via a network or in an embedded system or SoC.

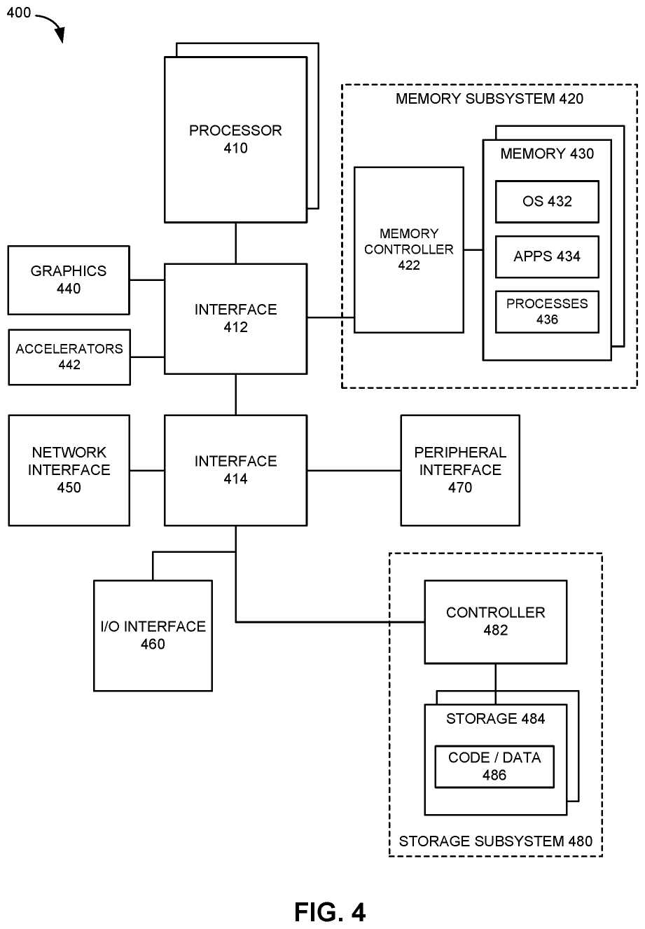

FIG. 4 depicts an example computing system. Compatibility between programmable devices in system 400 and processes executed in system 400 or another system can be determined and provided based on metadata associated with image files available to execute on the programmable devices, as described herein. Processor 410 can include any type of microprocessor, central processing unit (CPU), graphics processing unit (GPU), processing core, or other processing hardware to provide processing for system 400, or a combination of processors. Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some examples, system 400 includes interface 412 coupled to processor 410, which can represent a higher speed interface or a high throughput interface for system components that needs higher bandwidth connections, such as memory subsystem 420 or graphics interface components 440, or accelerators 442. Interface 412 represents an interface circuit, which can be a standalone component or integrated onto a processor die. Where present, graphics interface 440 interfaces to graphics components for providing a visual display to a user of system 400. In one example, graphics interface 440 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 440 generates a display based on data stored in memory 430 or based on operations executed by processor 410 or both. In one example, graphics interface 440 generates a display based on data stored in memory 430 or based on operations executed by processor 410 or both.

Accelerators 442 can be a fixed function or programmable offload engine that can be accessed or used by a processor 410. For example, an accelerator among accelerators 442 can provide compression (DC) capability, cryptography services such as public key encryption (PKE), cipher, hash/authentication capabilities, decryption, or other capabilities or services. In some embodiments, in addition or alternatively, an accelerator among accelerators 442 provides field select controller capabilities as described herein. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, Broadcom®, Nvidia®, IBM®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory. Network interface 450 can execute a virtual switch to provide virtual machine-to-virtual machine communications for virtual machines (or other VEEs) in a same server or among different servers.

Some examples of network interface 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as standards released by JEDEC (Joint Electronic Device Engineering Council) on Jun. 27, 2007).

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), or other memory.

A power source (not depicted) provides power to the components of system 400. More specifically, power source typically interfaces to one or multiple power supplies in system 400 to provide power to the components of system 400. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

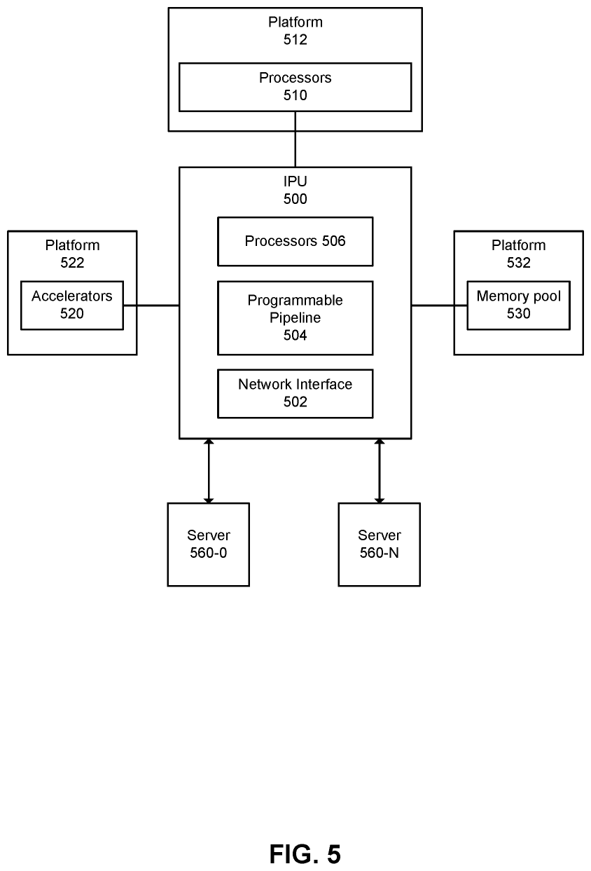

FIG. 5 depicts an example system. In this system, IPU 500 manages performance of one or more processes using one or more of processors 506, processors 510, accelerators 520, memory pool 530, or servers 540-0 to 540-N, where N is an integer of 1 or more. In some examples, processors 506 of IPU 500 can execute one or more processes, applications, VMs, containers, microservices, and so forth that request performance of workloads by one or more of: processors 510, accelerators 520, memory pool 530, and/or servers 540-0 to 540-N. IPU 500 can utilize network interface 502 or one or more device interfaces to communicate with processors 510, accelerators 520, memory pool 530, and/or servers 540-0 to 540-N. IPU 500 can utilize programmable pipeline 504 to process packets that are to be transmitted from network interface 502 or packets received from network interface 502. In some examples, programmable pipelines 504 and/or processors 510 can execute a virtual switch to provide virtual machine-to-virtual machine communications for virtual machines (or other VEEs) in a same server or among different servers.

In some examples, processors 506 can execute an orchestrator that can provide compatibility between programmable devices (e.g., processors 510, accelerators 520) and platforms (e.g., platforms 512, 522) connected thereto using metadata associated with image files available to execute on programmable devices, as described herein.

Configuration of operation of programmable pipeline 504 and/or processors 506 can be programmed using Programming Protocol-independent Packet Processors (P4), C, Python, Broadcom Network Programming Language (NPL), NVIDIA® CUDA®, NVIDIA® DOCA™ or x86 compatible executable binaries or other executable binaries.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes a non-transitory computer-readable medium comprising instructions stored thereon, that if executed by one or more processors, cause the one or more processors to: cause execution of a workload on a device based on characteristics of the device and based on metadata associated with the device identifying execution requirements and software and hardware compatibilities between the device and a platform environment.

Example 2 includes one or more examples, and includes instructions stored thereon, that if executed by one or more processors, cause the one or more processors to: based on the metadata, determine capability of the device and a device image configuration to perform the workload before the device is configured with the device image configuration to execute the workload on the device.

Example 3 includes one or more examples, wherein the characteristics of the device comprise operations of the device based on execution of a device image configuration.

Example 4 includes one or more examples, wherein the workload is initiated at a request of at least one software execution entity comprising one or more of: microservices, virtual machine, container, application, process, or function.

Example 5 includes one or more examples, wherein the software and hardware compatibilities between the device and a platform environment of the device comprise software stack compatibility.

Example 6 includes one or more examples, wherein the software stack compatibility comprises software package versions comprising one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

Example 7 includes one or more examples, wherein the metadata comprises the characteristics of the device and the software and hardware compatibilities and wherein the metadata is associated with a device image configuration and comprising instructions stored thereon, that if executed by one or more processors, cause the one or more processors to: validate source, integrity, and/or confidentiality of a portion of the metadata that comprises the characteristics of the device and the software and hardware compatibilities and based on a successful validation, utilize the portion of the metadata to determine compatibility between the platform environment and execution of the device image configuration by a programmable device.

Example 8 includes one or more examples, and includes instructions stored thereon, that if executed by one or more processors, cause the one or more processors to: perform an installation or update to a software stack executed by the platform to provide compatibility between the platform and the execution of the device image configuration by the programmable device.

Example 9 includes one or more examples, and includes instructions stored thereon, that if executed by one or more processors, cause the one or more processors to: select another device image configuration for execution by the programmable device to provide compatibility between the platform and the execution of the device image configuration by the programmable device.

Example 10 includes one or more examples, and includes an apparatus comprising: at least one processor and machine-readable storage medium comprising instructions thereon, that if executed by the at least one processor, cause the at least one processor to: cause execution of a workload on a device based on characteristics of the device and based on metadata associated with a device image configuration identifying execution requirements and software and hardware compatibilities between the device and a platform environment.

Example 11 includes one or more examples, wherein the characteristics of the device comprise operations of the device based on execution of a device image configuration.

Example 12 includes one or more examples, wherein the software and hardware compatibilities between the device and a platform environment of the accelerator device comprise software stack compatibility and wherein the software stack compatibility comprises one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

Example 13 includes one or more examples, wherein the metadata comprises the characteristics of the device and the software and hardware compatibilities and wherein the metadata is associated with a device image configuration and the at least one processor is to: validate source, integrity, and/or confidentiality of a portion of the metadata that comprises the characteristics of the device and the software and hardware compatibilities and based on a successful validation, utilize the portion of the metadata to determine compatibility between the platform environment and execution of the device image configuration by a programmable device.

Example 14 includes one or more examples, wherein the at least one processor is to: perform an update to a software stack executed by the platform to provide compatibility between the platform and the execution of the device image configuration by the programmable device or select another device image configuration for execution by the programmable device to provide compatibility between the platform and the execution of the device image configuration by the programmable device.

Example 15 includes one or more examples, and includes a method comprising: selecting an accelerator device to execute a workload based on characteristics of the accelerator device and based on software and hardware compatibilities between the device and a platform environment of the accelerator device.

Example 16 includes one or more examples, wherein the characteristics of the accelerator device comprise operations of the accelerator device based on execution of a device image configuration.

Example 17 includes one or more examples, wherein the software and hardware compatibilities between the accelerator device and a platform environment of the accelerator device comprise one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

Example 18 includes one or more examples, and includes a non-transitory computer-readable medium comprising instructions stored thereon, that if executed by one or more processors, cause the one or more processors to: generate a device image configuration and metadata associated with the device image configuration, wherein the metadata identifies execution requirements and software and hardware compatibilities between the device and a platform environment.

Example 19 includes one or more examples, wherein the metadata comprises structured metadata during a development of the device image configuration, wherein the structured metadata comprises one or more fields added by a first team and one or more fields added by a second team.

Example 20 includes one or more examples, wherein the structured metadata includes data for authentication, integrity checking, and confidentiality.

What is claimed is:

1. A non-transitory computer-readable medium comprising instructions stored thereon, that if executed by one or more processors, cause the one or more processors to:
cause execution of a workload on a device based on characteristics of the device and based on metadata associated with the device identifying execution requirements and software and hardware compatibilities between the device and a platform environment.

2. The computer-readable medium of claim 1, comprising instructions stored thereon, that if executed by one or more processors, cause the one or more processors to:
based on the metadata, determine capability of the device and a device image configuration to perform the workload before the device is configured with the device image configuration to execute the workload on the device.

3. The computer-readable medium of claim 1, wherein the characteristics of the device comprise operations of the device based on execution of a device image configuration.

4. The computer-readable medium of claim 1, wherein the workload is initiated at a request of at least one software execution entity comprising one or more of: microservices, virtual machine, container, application, process, or function.

5. The computer-readable medium of claim 1, wherein the software and hardware compatibilities between the device and a platform environment of the device comprise software stack compatibility.

6. The computer-readable medium of claim 5, wherein the software stack compatibility comprises software package versions comprising one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

7. The computer-readable medium of claim 1, wherein the metadata comprises the characteristics of the device and the software and hardware compatibilities and wherein the metadata is associated with a device image configuration and comprising instructions stored thereon, that if executed by one or more processors, cause the one or more processors to:
validate source, integrity, and/or confidentiality of a portion of the metadata that comprises the characteristics of the device and the software and hardware compatibilities and
based on a successful validation, utilize the portion of the metadata to determine compatibility between the platform environment and execution of the device image configuration by a programmable device.

8. The computer-readable medium of claim 7, comprising instructions stored thereon, that if executed by one or more processors, cause the one or more processors to:
perform an installation or update to a software stack executed by the platform to provide compatibility between the platform and the execution of the device image configuration by the programmable device.

9. The computer-readable medium of claim 7, comprising instructions stored thereon, that if executed by one or more processors, cause the one or more processors to:
select another device image configuration for execution by the programmable device to provide compatibility between the platform and the execution of the device image configuration by the programmable device.

10. An apparatus comprising:
at least one processor and
machine-readable storage medium comprising instructions thereon, that if executed by the at least one processor, cause the at least one processor to:
cause execution of a workload on a device based on characteristics of the device and based on metadata associated with a device image configuration identifying execution requirements and software and hardware compatibilities between the device and a platform environment.

11. The apparatus of claim 10, wherein the characteristics of the device comprise operations of the device based on execution of a device image configuration.

12. The apparatus of claim 11, wherein the software and hardware compatibilities between the device and a platform environment of the accelerator device comprise software stack compatibility and wherein the software stack compatibility comprises one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

13. The apparatus of claim 10, wherein the metadata comprises the characteristics of the device and the software and hardware compatibilities and wherein the metadata is associated with a device image configuration and the at least one processor is to:
validate source, integrity, and/or confidentiality of a portion of the metadata that comprises the characteristics of the device and the software and hardware compatibilities and
based on a successful validation, utilize the portion of the metadata to determine compatibility between the platform environment and execution of the device image configuration by a programmable device.

14. The apparatus of claim 13, wherein the at least one processor is to:
perform an update to a software stack executed by the platform to provide compatibility between the platform and the execution of the device image configuration by the programmable device or
select another device image configuration for execution by the programmable device to provide compatibility between the platform and the execution of the device image configuration by the programmable device.

15. A method comprising:
selecting an accelerator device to execute a workload based on characteristics of the accelerator device and based on software and hardware compatibilities between the device and a platform environment of the accelerator device.

16. The method of claim 15, wherein the characteristics of the accelerator device comprise operations of the accelerator device based on execution of a device image configuration.

17. The method of claim 15, wherein the software and hardware compatibilities between the accelerator device and a platform environment of the accelerator device comprise one or more of: permitted operating system versions, a range of compatible device driver versions, permitted Data Plane Development Kit (DPDK) versions, permitted Storage Performance Development Kit (SPDK) versions, encryption versions, decryption versions, database versions, artificial intelligence (AI) or machine learning (ML) library versions, image processing versions, video processing versions, or device interface compatibility.

18. A non-transitory computer-readable medium comprising instructions stored thereon, that if executed by one or more processors, cause the one or more processors to:
generate a device image configuration and metadata associated with the device image configuration, wherein the metadata identifies execution requirements and software and hardware compatibilities between the device and a platform environment.

19. The computer-readable medium of claim 18, wherein the metadata comprises structured metadata during a development of the device image configuration, wherein the structured metadata comprises one or more fields added by a first team and one or more fields added by a second team.

20. The computer-readable medium of claim 19, wherein the structured metadata includes data for authentication, integrity checking, and confidentiality.
